(19) United States
(12) Patent Application Publication
(10) Pub. No.: US 2026/0050676 A1
(43) Pub. Date: Feb. 19, 2026

(54) Method for Providing a Digital Key

(71) Applicants: Elif Bilge Kavun, Passau (DE); WIZnet Germany GmbH, Kleinniedesheim (DE)

(72) Inventors: Elif Bilge Kavun, Passau (DE); Witali Bartsch, Leverkusen (DE)

(21) Appl. No.: 19/104,526

(22) PCT Filed: Aug. 21, 2023
(86) PCT No.: PCT/EP2023/072880

§ 371 Date: Feb. 18, 2025

(30) Foreign Application Priority Data
Aug. 19, 2022 (EP) 22191189.4

(51) Int. Cl. G06F 21/60; H04L 9/08

(52) U.S. Cl. CPC G06F 21/602; H04L 9/0816

(57) ABSTRACT

A method for providing a digital key to a processor unit using a computer system. The digital key is provided within an application code and a sequence of instructions is stored in the application code. In the method, a digital key is generated using a computer system and divided into at least two key parts. The key parts are embedded in at least two instructions of the application code which is transmitted from the computer system to the processor unit.

### CROSS-REFERENCE TO RELATED APPLICATIONS

This application is the United States national phase of International Patent Application No. PCT/EP2023/072880 filed Aug. 21, 2023, and claims priority to European Patent Application No. 22191189.4 filed Aug. 19, 2022, the disclosures of which are hereby incorporated by reference in their entireties.

### BACKGROUND OF THE INVENTION

### Field of the Invention

The present invention is in the field of cryptography. In particular, the present invention relates to a method for providing a digital key to a processor unit by a computer system and a corresponding method for reconstructing a digital key by a processor unit.

In some application scenarios, it is desirable to provide a digital key to a processor unit. The digital key contains secret information that is intended for a specific processor unit. For example, the secret information provided can be used for subsequent authentication of the processor unit.

Numerous methods for providing digital keys are known from cryptography, each of which has advantages and disadvantages. For all methods, however, it is necessary to provide the digital key in a secure manner so that unauthorized persons do not have access to the key provided. Even if no method can generally offer one hundred percent security, it is at least desirable to make a potential attack by an unauthorized person as difficult as possible.

### Description of Related Art

US 2019/028273 A1 describes a method for encrypting data. This method does not use conventional keys for encryption. Instead, future events are used as a secret key for encryption. Here, transient keys that are not permanently stored are used to encrypt the data. In this manner the risk of key theft is reduced.

A method for encrypting data is proposed in US 2020/159676 A1. This method uses cryptographically encoded pointers in a multi-party environment. For example, first instructions are provided to generate a first address key for a private memory area in a memory unit and to generate a first cryptographically encoded pointer directed to the private memory area of the memory unit. The generation of the first cryptographically encoded pointer includes the storage of context information that is assigned to the private memory area. In this method, it may be provided that a party in the multi-party environment is allowed to access the first address key and the first cryptographically generated pointer directed to the private storage area.

### SUMMARY OF THE INVENTION

Taking into account the situation described above, it is the object of the present invention to provide a method for providing a digital key for a processor unit in which access to the digital key by an unauthorized person is made as difficult as possible. To achieve the above object, the present invention proposes a method for providing a digital key by a computer system for a processor unit, wherein the digital key is provided within an application code and wherein a sequence of instructions is stored in the application code. In the method according to the invention, the following method steps are provided:
generating a digital key to be provided by a computer system;
splitting the digital key into at least two key parts;
embedding the key parts in at least two instructions of the application code; and
transmitting the application code from the computer system to the processor unit.

In the method according to the invention, the digital key is embedded in an application code and “hidden” therein. The different key parts are stored in different instructions of the application code. The processor unit knows where the secret information is stored in the application code so that the processor unit can reconstruct the digital key and the secret information it contains after receiving the application code. In this way, the key to be transmitted is hidden in the application code in such a way that it is difficult for a potential attacker to reconstruct the secret information, as he does not know where the individual key parts are stored in the application code. In this respect, the application code has areas in which instructions are encoded and areas in which the secret information is encoded. The splitting of the digital key and the embedding of the key parts is carried out by the computer system, which can also be referred to as a compiler system in the context of the present invention.

According to one embodiment of the present invention, it may be provided that embedding the key portions in at least two instructions of the application code comprises embedding the key portions in specific fields of the instructions that typically remain unused. As can be seen in practice, some instruction sets for processor units contain instructions with specific fields that are not used. It is therefore advantageous to arrange the key parts in the unused fields of the instructions. In this way, a digital key can be provided particularly efficiently. The preferred embodiment therefore allows a digital key to be embedded in an application code without increasing the overall size of the application code.

Preferably, it can be provided that the application code is designed as a RISC-V (Re-duced Instruction Set Computers V) application code, wherein the instructions are designed in particular as R-type instructions and wherein the embedding of the key parts is preferably carried out in Funct7 fields. As explained above, the key parts can preferably be embedded in unused fields of the instructions. An example of this are the R-type instructions of the RISC-V instruction sets. Within the R-type instructions, for example, the Funct7 fields are provided, which are typically unused. This makes the Funct7 fields particularly suitable for embedding the key parts in these fields. In this way, a digital key can be embedded in an application code without increasing the amount of data required by the application code. This ensures a particularly efficient provision of the digital key. Even if, for example, the Funct7 fields of the R-type instructions were mentioned above, it is, however, apparent to a person skilled in the art that the present application is not limited to the fields mentioned. Rather, the key parts can also be embedded in a variety of other fields or other instructions.

In an advantageous embodiment of the method according to the invention, it may further be provided that the generation of the digital key to be provided by the computer system comprises the following method steps:
generation of a first key by the computer system, whereby the first key contains secret information that is to be transmitted to the processor unit;
reading a hardware identifier from the processor unit, the hardware identifier comprising a unique identifier of the processor unit; and
calculating the digital key to be provided by the computer system, the calculation being carried out from the first key and the hardware identifier.

The first key can also be regarded as a software key, as it is generated on a software basis and does not contain any hardware-related information. In particular, this first key does not contain any hardware-dependent information that specifies the processor unit. The hardware identifier, on the other hand, contains specific information about the processor unit. In particular, the hardware identifier allows a unique assignment of the respective processor unit for which the digital key is to be provided. The hardware identifier can also be referred to as a hardware fingerprint. In general, various hardware identifiers are known which allow the unique identification of a processor unit. Some specific examples of the hardware identifier are given below. The hardware identifier can be read out by a request from the computer system to the processor unit and a subsequent response from the processor unit to the computer system. Calculating the digital key to be provided from the first key and the hardware identifier has the advantage that the hardware identifier of the processor unit must be known for the subsequent reconstruction of the first key. In other words, the first key is encrypted with the hardware identifier. An unauthorized person who has previously succeeded in gaining knowledge of the digital key can therefore not easily reconstruct the first key. In this way, the safety of the method according to the invention is further increased. There are various options for calculating the digital key to be provided from the first key and the hardware identifier. For example, the digital key can be calculated as the sum of the first key and the hardware identifier. In this case, the processor unit in possession of its specific hardware identifier can calculate the first key by subtracting the hardware identifier from the received digital key. In an analogous manner, it can also be provided that the digital key to be provided is calculated by multiplying the first key and the hardware identifier or by subtracting the hardware identifier from the first key.

According to the method according to the invention, it may be provided that the hardware identifier comprises a serial number of the processor unit or a serial number of a memory element of the processor unit.

Furthermore, the method according to the invention may provide that the hardware identifier comprises specific information of a memory element, in particular a DRAM memory element of the processor unit. This makes use of the fact that the memory elements of a processor unit are in fact never completely identical, but have marginal differences, which makes it possible to identify the memory element or the processor unit.

The method according to the invention may also provide that calculating the digital key to be provided from the first key and the hardware identifier comprises applying an XOR operator to the first key and the hardware identifier.

According to a preferred embodiment of the method of the invention, it may be provided that the hardware identifier is designed as a temperature-dependent hardware identifier. This can further increase the safety of the method according to the invention. An attacker who has previously succeeded in gaining knowledge of the digital key provided and also knowledge of a hardware identifier still cannot easily reconstruct the first key, as the key required for decryption (=hardware identifier) can only be read at a specific temperature. For example, if a hardware identifier was read at a temperature of 20° C. during the generation of the digital key to be provided by the computer system, but the attack by the unauthorized person was carried out at a temperature of 25° C., the attacker will obtain a hardware identifier that is unsuitable for reconstructing the first key. This makes a possible attack by an unauthorized person significantly more difficult.

According to an advantageous embodiment of the method according to the invention, it may be provided that the hardware identifier comprises information about the specific charging time of the capacitors of the DRAM memory element or information about the latency times of the DRAM memory element. The specific charging time of the capacitors of the DRAM memory element and the information on the latency times of the DRAM memory element are specific variables that allow reliable identification of the corresponding DRAM memory element. During the subsequent reconstruction of the first key, the processor unit, which has knowledge of the information relating to the DRAM memory element, can decrypt the digital key using this information. For a potential attacker who does not have this hardware information, it is impossible (or at least significantly more difficult) to gain possession of the first key without the necessary hardware information.

Furthermore, according to a preferred embodiment of the method according to the invention, it may be provided that the hardware identifier is determined by a method based on machine learning. The method based on machine learning may have previously been trained with training data. The training data can, for example, have temperature values (or temperature ranges) and read-out measured values (e.g. specifically read-out information of a DRAM memory element, in particular specific information about the specific charging time of the capacitors or about the latency times of the memory element) as input variables and hardware identifiers corresponding to the input variables as output variables. The measured values read out can be temperature-dependent values in particular. In this way, the machine learning-based method can learn during a training process which hardware identifier is to be generated for one or more processor units at certain temperatures. If a hardware identifier or measured values assigned to the hardware identifier are then read out at a certain temperature, the machine learning-based method can, for example, calculate a uniform hardware identifier that allows the processor unit to be uniquely identified. In this way, temperature-dependent effects can be compensated for so that the same hardware identifier is always output for a processor unit regardless of the current ambient temperature.

In addition, to achieve the above described object, a method for reconstructing a digital key by a processor unit is proposed, the method comprising the following steps:
receiving an application code from a computer system, wherein a sequence of instructions and a digital key are stored in the application code; and wherein the digital key comprises at least two key parts that are not contiguously stored in the application code;
assembling the digital key from at least two key parts.

The processor unit has information in advance about the locations in which the individual key parts are stored in the application code. For example, the processor unit may know that a specific field of a specific instruction is provided for storing the key parts. In this way, the processor unit can search the application code for the specific fields, extract the individual key parts from these fields and then combine the individual key parts into a digital key. Furthermore, the processor unit can be modified in such a way that it interprets additional instructions with regard to the total number of key parts stored in the application code. This is advantageous in that the length of the overall key can be determined as early as possible for later use. This also enables effective partial use of the overall key for various applications at a later date. It is well known from the state of the art in cryptography that the same key should preferably only be used for a specific purpose, such as encryption or the creation of a digital signature, but not both at the same time.

Preferably, it can be provided that the application code is designed as a RISC-V application code, wherein the instructions are designed in particular as R-type instructions and wherein the embedding of the key parts is preferably carried out in Funct7 fields.

It may also be provided that the method comprises the following step:
calculating a first key containing secret information from the digital key received from the computer system and a hardware identifier of the processor unit.

The calculation of the first key depends on how the digital key was previously calculated. The first digital key can be calculated, for example, by addition, subtraction or by applying the XOR operator to the received digital key and the hardware identifier.

It may preferably be provided that the hardware identifier comprises specific information of a DRAM memory element of the processor unit.

In an advantageous manner, it can be provided that the hardware identifier is designed as a temperature-dependent hardware identifier.

It may further be provided that the hardware identifier comprises information about the specific charging time of the capacitors of the DRAM memory element or information about the latency times of the DRAM memory element.

Furthermore, a computer system comprising a computing unit, a memory unit and a communication unit is proposed for achieving the object described above, wherein the computer system is provided for providing a digital key within an application code and wherein the computing unit of the computer system is configured to:
provide a digital key;
divide the digital key into at least two key parts;
embed the key parts in at least two instructions of the application code; and
transmit the application code to a processor unit.

In addition, a processor unit for reconstructing a digital key is proposed for solving the task described above, the processor unit being configured to:
receive an application code from a computer system, wherein a sequence of instructions and a digital key are stored in the application code; and wherein the digital key comprises at least two key parts that are not contiguously stored in the application code;
assemble the digital key from the at least two key parts.

Furthermore, in order to advantageously perform the present task and to increase security, a cryptographic computing unit can be provided which, in cooperation with the latter units of the overall system, on the one hand applies any error corrections, but on the other hand isolates the overall key from the processor unit in such a way that cryptographic operations such as encryption or digital signatures are performed directly by this unit and only the results of these operations are transmitted to the processor unit. This results in a strong separation and secrecy of the overall key from the higher-level program logic.

### BRIEF DESCRIPTION OF THE DRAWINGS

In the following, the present invention is described in more detail with reference to the Figures. In the Figures:

FIG. 1 shows a first embodiment of the method according to the invention,

FIG. 2 shows the method steps for generating the digital key to be provided according to an embodiment example of the invention,

FIG. 3 shows an instruction with various fields that are partly occupied and partly unused, and

FIG. 4 shows a system comprising a computer system and a processor unit.

### DESCRIPTION OF THE INVENTION

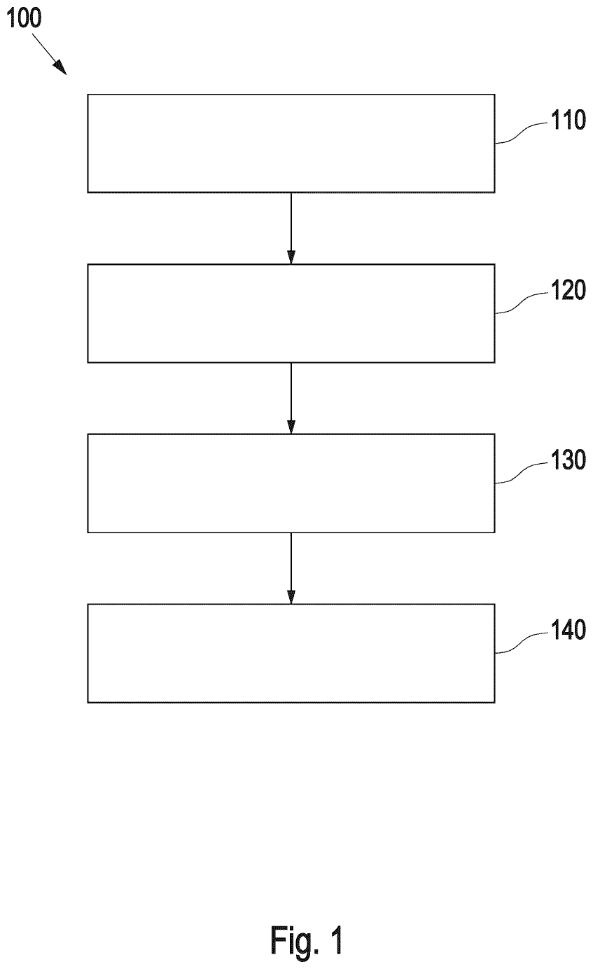

FIG. 1 shows a first embodiment of the method 100 according to the invention. In this embodiment, the method 100 according to the invention has the method steps 110-140. In the first method step 110, a computer system generates a digital key to be provided. The digital key can be a randomly generated number. The digital key contains information that should be provided to the processor unit in a secure manner so that potential attackers cannot easily reconstruct this key. In the second method step 120, the digital key is divided into at least two key parts. In practice, the digital key can be divided into several 10, several 100 or even several 1000 key parts. The principle according to the invention remains the same regardless of the exact number of key parts. Subsequently, in the third method step 130, the respective key parts are embedded in at least two instructions 20 of the application code. According to a particularly efficient embodiment of the present invention, the key parts can be embedded in specific fields of instructions that normally remain unused. This allows a digital key to be embedded in an application code without affecting the overall size of the application code. On the one hand, this is particularly efficient because a digital key can be integrated without increasing the amount of data required by the application code. On the other hand, this prevents a potential attacker from being able to deduce whether the application code contains a key or not based on the size of the application code. For example, the application code can be a RISC-V application code, the key parts being embedded in Funct7 fields of the R-type instructions. Subsequently, in the fourth method step 140, the application code is transmitted from the computer system to the processor unit. The processor unit can then reconstruct the digital key from the application code received.

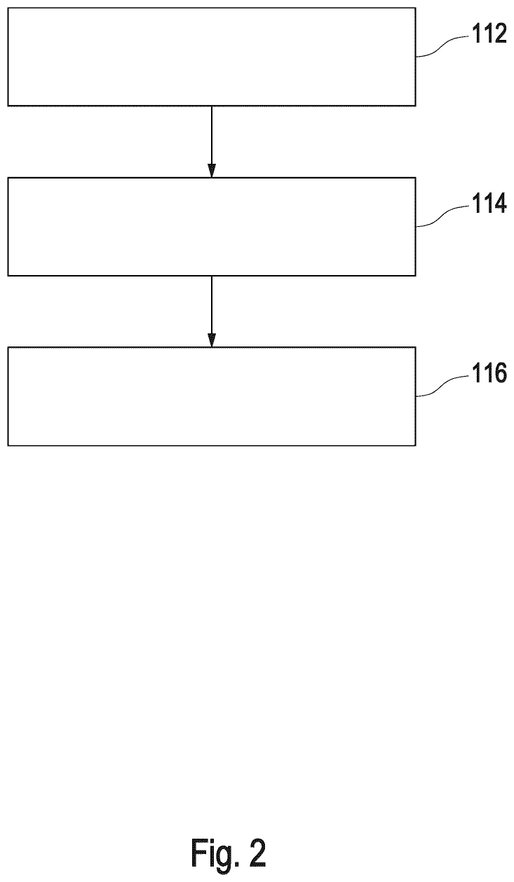

FIG. 2 shows the method steps for generating (step 110 in FIG. 1) the digital key to be provided by the computer system according to a first embodiment of the invention. In a first sub-step 112, a first key is generated containing secret information to be transmitted to the processor unit. The first key is encrypted before transmission to the processor unit using a hardware-based key so that a potential attacker cannot easily reconstruct this first key. In the second sub-step 114, a hardware identifier of the processor unit is read out. The hardware identifier (also known as the hardware ID) has a unique identifier for the processor unit and therefore enables the processor unit to be uniquely identified. In particular, the hardware identifier may contain specific information of a DRAM memory element of the processor unit. In a third sub-step 116, the digital key to be provided, which is transmitted to the processor unit, is calculated from the first key and the hardware identifier. As explained above, the calculation can be performed, for example, by addition, subtraction or by applying the XOR operator to the first digital key and the hardware identifier. Here, the first digital key and the hardware identifier can, for example, be binary numbers with 128 bits or 256 bits each.

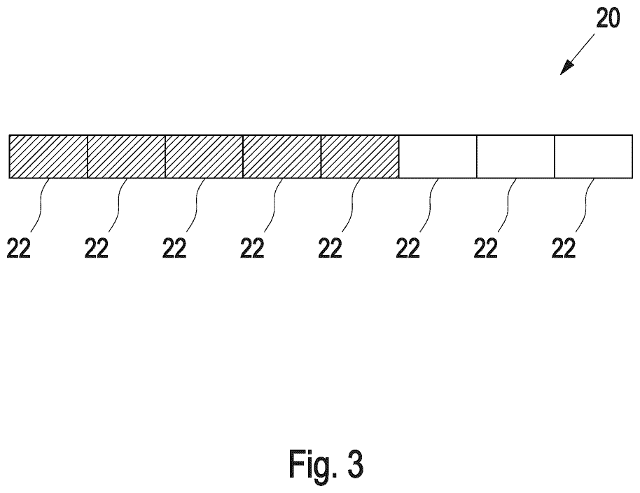

FIG. 3 shows an instruction 20 with various fields 22, where the fields 22 are partly occupied and partly unused. For example, it may be provided that each field 22 has a length of 10 bits. The instruction 20 shown in FIG. 3 can therefore comprise 80 bits. Of the total of eight fields 22, five fields 22 contain information relating to instruction 20. These are shown in FIG. 3 as hatched fields 22. Furthermore, the instruction 20 shown in FIG. 3 includes three fields 22 that are unused. The unused fields 22 are particularly suitable as containers for holding the key parts. If the key parts are stored in these containers, the digital key can be provided in a particularly efficient manner without changing the amount of data required by the application code.

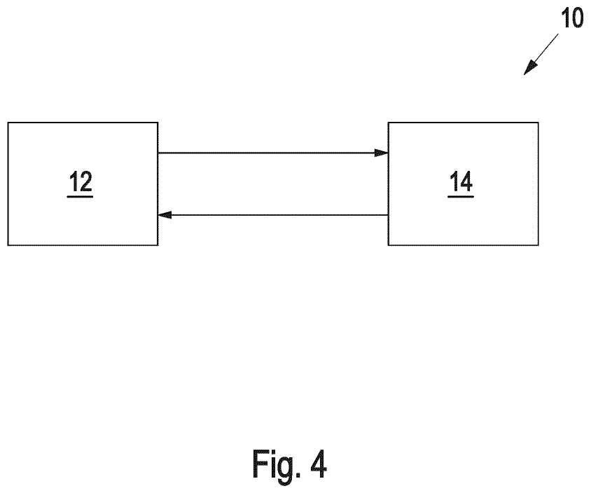

FIG. 4 shows a system 10 comprising a computer system 12 and a processor unit 14. In the embodiment shown in FIG. 4, there is bidirectional communication between the computer system 12 and the processor unit 14. For example, the computer system 12 can read out a hardware identifier of the processor unit 14 and then calculate the digital key to be provided from a first key, which contains secret information, and the hardware identifier. In this way, the computer system 12 can generate a key to be provided that is encrypted with hardware information of the processor unit 14. After the digital key to be provided is generated by the computer system 12, the digital key to be provided may be divided into at least two key parts, wherein the individual key parts are embedded in at least two instructions of the application code before the application code is transmitted to the processing unit 14.

### LIST OF REFERENCE NUMERALS

10 system
12 computer system
14 processor unit
20 instruction
22 field
100 method
110 first method step
112 first sub-step
114 second sub-step
116 third sub-step
120 second method step
130 third method step
140 fourth method step

1. A method for providing a digital key to a processor unit using a computer system, the digital key being provided within an application code, and a sequence of instructions being stored in the application code, the method comprising the following steps:
generating a digital key to be provided by a computer system;
splitting the digital key into at least two key parts;
embedding the key parts in at least two instructions of the application code; and
transmitting the application code from the computer system to the processor unit.

2. The method according to claim 1, wherein embedding the key parts in at least two instructions of the application code comprises embedding the key portions in specific fields of the instructions that typically remain unused.

3. The method according to claim 1; wherein the application code is designed as a RISC-V application code, the instructions being designed in particular as R-type instructions and the embedding of the key parts being preferably carried out in Funct7 fields.

4. The method according to claim 1, wherein generating the digital key to be provided by the computer system comprises the following steps:
generating a first key containing secret information to be transmitted to the processor unit;
reading a hardware identifier, the hardware identifier comprising a unique identifier of the processor unit; and
calculating the digital key to be provided from the first key and the hardware identifier.

5. The method according to claim 4, wherein the hardware identifier comprises specific information of a DRAM memory element of the processor unit.

6. The method according to claim 4; wherein calculating the digital key to be provided from the first key and the hardware identifier comprises applying an XOR operation to the first key and the hardware identifier.

7. The method according to claim 4, wherein the hardware identifier is designed as a temperature-dependent hardware identifier.

8. The method according to claim 7, wherein the hardware identifier comprises information about the specific charging time of the capacitors of the DRAM memory element or information about the latency times of the DRAM memory element.

9. The method according to claim 4, wherein the hardware identifier is determined by a machine learning-based method.

10. A method for reconstructing a digital key by a processor unit comprising the following steps:
receiving an application code from a computer system, a sequence of instructions and a digital key being stored in the application code; and the digital key comprising at least two key parts that are not contiguously stored in the application code; and
assembling the digital key from the at least two key parts.

11. The method according to claim 10, wherein the application code is designed as a RISC-V application code, the instructions being designed in particular as R-type instructions and the embedding of the key parts being preferably carried out in Funct7 fields.

12. The method according to claim 10, wherein the method further comprises the following step:
calculating a first key containing secret information from the digital key received from the computer system and a hardware identifier of the processor unit.

13. The method according to claim 10, wherein the hardware identifier comprises specific information of a DRAM memory element of the processor unit.

14. The method according to claim 10, wherein the hardware identifier is designed as a temperature-dependent hardware identifier.

15. The method according to claim 10, wherein the hardware identifier comprises information about the specific charging time of the capacitors of the DRAM memory element or information about the latency times of the DRAM memory element.
